(19) United States
(12) Patent Application Publication
(10) Pub. No.: US 2016/0327718 A1
(43) Pub. Date: Nov. 10, 2016

(54) BACKLIGHT MODULE FOR LIQUID CRYSTAL DISPLAY

(71) Applicant: Wuhan China Star Optoelectronics Technology Co., Ltd., Hubei (CN)

(72) Inventors: Zhongjie LIU, Wuhan, Hubei (CN); Yanxue ZHANG, Wuhan, Hubei (CN); Wei GUO, Wuhan, Hubei (CN)

(21) Appl. No.: 14/782,241

(22) PCT Filed: Aug. 24, 2015
(86) PCT No.: PCT/CN2015/087929

§ 371 Date: Oct. 2, 2015

(30) Foreign Application Priority Data
May 5, 2015 (CN) 201510225239.3

(51) Int. Cl. F21V 8/00

(52) U.S. Cl. CPC G02B 6/005; G02B 6/0055

(57) ABSTRACT

A backlight module including a light guide plate, an optical film and a light-shielding adhesive. The optical film is disposed on a top surface of the light guide plate; a portion of the light-shielding adhesive adhering to an edge of a top surface of the optical film; and another portion of the light-shielding adhesive adhering to a side surface of the optical film and a side surface of the light guide plate, and adhering to an edge of a bottom surface of the light guide plate. Further disclosed is a liquid crystal display having the backlight module with light-shielding adhesives used to fix the optical film onto the light guide plate, and the light-shielding adhesive is used to fix the light guide plate and the optical film into the back frame without using a glue frame to fix the light guide plate and the optical film into the back frame.

### TECHNICAL FIELD

The present disclosure relates to liquid crystal display field, and more particularly, to a backlight module and a liquid crystal display having the backlight module.

### BACKGROUND ART

Currently, market is increasingly seeking narrow bezel of portable products, for example, the bezels of devices which require a liquid crystal display, such as current mobile phones, tablet PCs, and the like, are manufactured narrower and narrower. Thus, the bezel of the liquid crystal display needs to be manufactured narrower and narrower. In the entire liquid crystal display, whether a bezel of a backlight module can be narrowed determines whether the liquid crystal display can realize narrow bezel.

In the prior art, a minimum width of a bezel of a backlight module may reach 0.65 mm, wherein a width of a glue frame is 0.2 mm to 0.3 mm. Currently, a width of the bezel is generally decreased by changing a structure of the glue frame or narrowing an attached length of the light-shielding adhesive, which may bring three problems, however: 1. manufacture of a specific glue frame structure has a great challenge with respect to the existing injection molding and stamping technology, which may directly result in increasing costs; 2. narrowing the attached length of the light-shielding adhesive may decrease attaching accuracy, thereby decreasing reliability of products; 3. narrowing the attached length of the light-shielding adhesive may cause a length of the light-shielding adhesive attached to the optical film to be narrower, thereby decreasing light-shielding performance and influencing optical taste of the backlight module.

### SUMMARY

In order to solve the above problem existing in the prior art, the present disclosure aims to provide a backlight module, which includes a light guide plate, an optical film and a light-shielding adhesive. The optical film is disposed on a top surface of the light guide plate; a portion of the light-shielding adhesive adheres to an edge of a top surface of the optical film, and another portion of the light-shielding adhesive adheres to a side surface of the optical film and a side surface of the light guide plate, and extendedly adheres to an edge of a bottom surface of the light guide plate.

The present disclosure also aims to provide a liquid crystal display, which includes the backlight module and a liquid crystal panel oppositely disposed. The backlight module provides a display light source for the liquid crystal panel.

Further, the light-shielding adhesive takes a shape of U.

Further, the backlight module does not include a glue frame.

Further, the backlight module further includes a back frame including a bottom plate and a side plate located at a side end of the bottom plate. The light guide plate is disposed on the bottom plate, and the light-shielding adhesive adhered to a side surface of the optical film and a side surface of the light guide plate adheres to the side plate.

Further, the backlight module further includes a reflector plate, which is disposed between the light-shielding adhesive adhered to the edge of the bottom surface of the light guide plate and the bottom plate.

Advantageous effects of the present disclosure is as follows: in the backlight module of the present disclosure, the light-shielding adhesive is used to fix the optical film onto the light guide plate, and the light-shielding adhesive is used to fix the light guide plate and the optical film into the back frame without using the glue frame to fix the light guide plate and the optical film into the back frame in the prior art. Since a thickness of the light-shielding adhesive is far less than a thickness of the glue frame, a bezel width of the backlight module may be decreased significantly.

### BRIEF DESCRIPTION OF THE DRAWINGS

The above and/or other aspects, features and advantages of the embodiments in the present disclosure will become apparent and more readily appreciated from the following description, taken in conjunction with the accompanying drawing in which:

FIG. 1 is a partial side view of a liquid crystal display according to an embodiment of the present disclosure.

### DETAILED DESCRIPTION OF EXEMPLARY EMBODIMENTS

Embodiments of the present disclosure will be described in detail below by referring to the accompany drawing. However, the present disclosure can be implemented in many different forms, and are not to be construed as being limited to the specific embodiments described herein. Rather, these embodiments are provided for explaining the principle and actual application of the present disclosure, thus other skilled in the art can understand various embodiments and amendments which are suitable for specific intended applications of the present disclosure. In the drawings, in order to clarify the device, thicknesses of layers and regions are exaggerated.

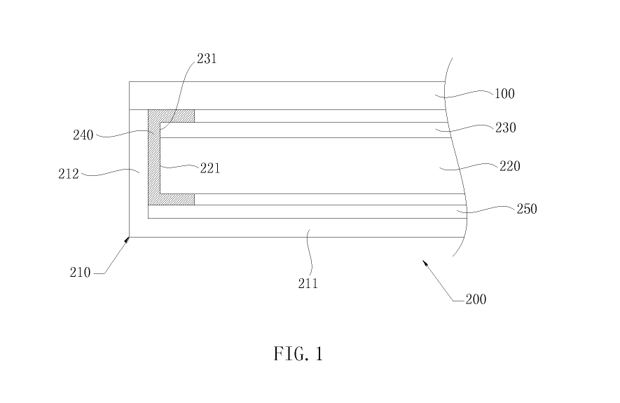

FIG. 1 is a partial side view of a liquid crystal display according to an embodiment of the present disclosure.

Referring to FIG. 1, a liquid crystal display in accordance with an embodiment of the present disclosure includes a liquid crystal panel 100 and a backlight module 200 oppositely disposed, wherein the backlight module 200 provides a display light source having high brightness to the liquid crystal panel 100 having high resolution, so that the liquid crystal panel 100 displays an image. In the present embodiment, since the main invention point of the present disclosure aims at the backlight module 200, in order to avoid repetition, the specific structure of the liquid crystal panel 100 will not be described in detail herein. Those skilled in the art may refer to a structure of the liquid crystal panel disclosed in the prior art.

The backlight module 200 according to an embodiment of the present disclosure will be described in detail below. Referring to FIG. 1. The backlight module 200 according to the embodiment of the present disclosure includes: a back frame (or called a back plate) 210, a light guide plate 220, an optical film 230 and a light-shielding adhesive 240.

FIG. 1 only illustrates a bottom plate 211 included in the back frame 210 and a side plate 212 located at a side end of the bottom plate 211. It should be understood that the back frame 210 generally includes the bottom plate 211 and side plates 212 located at four side ends of the bottom plate 211, respectively.

The light guide plate 220 is disposed on the bottom plate 211 of the back frame 210. In the present embodiment, a side surface 221 of the light guide plate 220 is adjacent to the side plate 212 of the back frame 210. The optical film 230 is disposed on the top surface of the light guide plate 220. In the present embodiment, the number of the optical film 230 is not specifically defined.

The light-shielding adhesive 240 may be, for example, a black and white light-shielding adhesive. A portion of the light-shielding adhesive 240 adheres to an edge of a top surface of the optical film 230; another portion of the light-shielding adhesive 240 adheres to a side surface 231 of the optical film 230 and a side surface 221 of the light guide plate 220; and the other portion of the light-shielding adhesive 240 extendedly adheres to an edge of a bottom surface of the light guide plate 220. That is to say, the light-shielding adhesive 240 in the present embodiment takes a shape of U overall, and adheres to the edge of the top surface of the optical film 230, the side surface 231 of the optical film 230, the side surface 221 of the light guide plate 220 and the edge of the bottom surface of the light guide plate 220, so that the optical film 230 is fixed on the top surface of the light guide plate 220.

Furthermore, the light-shielding adhesive 240 adhered to the side surface 231 of the optical film 230 and the side surface 221 of the light guide plate 220 is adhered together with the side plate 212 of the light guide plate 220. Thus, the light guide plate 220 and the optical film 230 may be fixed in the back frame 210, which omits the glue frame to fix the light guide plate and the optical film in the prior art. However, a width of the light-shielding adhesive 240 is far less than a width of the glue frame, thus a bezel width of the backlight module 200 may be decreased significantly.

The backlight module 200 according to the embodiment of the present disclosure further includes a reflector plate 250, which is disposed between the light guide plate 220 and the bottom plate 211 of the back frame 210, and the reflector plate 250 extends to the side plate 212 of the back frame 210. That is to say, a portion of the reflector plate 250 extending to the side plate 212 of the back frame 210 is disposed between the light-shielding adhesive 240 adhered to the edge of the light guide plate 220 and the bottom plate 211 of the back frame 210. The reflector plate 250 can reflect the light reaching thereon back to the light guide plate 220, thereby improving light utilization ratio of the backlight module 200.

In summary, according to the embodiment of the present disclosure, in the backlight module, the light-shielding adhesive is used to fix the optical film onto the light guide plate, and the light-shielding adhesive is used to fix the light guide plate and the optical film into the back frame, without using a glue frame to fix the light guide plate and the optical film into the back frame in the prior art. Since a thickness of the light-shielding adhesive is far less than a thickness of the glue frame, a bezel width of the backlight module may be decreased significantly.

While the present disclosure has been shown and described with reference to the specific embodiments, it will be understood by those skilled in the art that various changes in form and details may be made therein without departing from the spirit and scope of the present disclosure as defined by the appended claims and its equivalents.

What is claimed is:

1. A backlight module, comprising:
a light guide plate;
an optical film disposed on a top surface of the light guide plate; and
a light-shielding adhesive, a portion of which adheres to an edge of a top surface of the optical film, and another portion adheres to a side surface of the optical film and a side surface of the light guide plate, and extendedly adheres to an edge of a bottom surface of the light guide plate.

2. The backlight module of claim 1, wherein the light-shielding adhesive takes a shape of U.

3. The backlight module of claim 1, wherein the backlight module does not comprise a glue frame.

4. The backlight module of claim 2, wherein the backlight module does not comprise a glue frame.

5. The backlight module of claim 3, wherein the backlight module further comprises a back frame including a bottom plate and a side plate located at a side end of the bottom plate, the light guide plate is disposed on the bottom plate, and the light-shielding adhesive adhered to the side surface of the optical film and the side surface of the light guide panel adheres to the side plate.

6. The backlight module of claim 4, wherein the backlight module further comprises a back frame including a bottom plate and a side plate located at a side end of the bottom plate, the light guide plate is disposed on the bottom plate, and the light-shielding adhesive adhered to the side surface of the optical film and the side surface of the light guide panel adheres to the side plate.

7. The backlight module of claim 5, wherein the backlight module further comprises a reflector plate disposed between the light-shielding adhesive adhered to the edge of the bottom surface of the light guide plate and the bottom plate.

8. A liquid crystal display, comprising:
a backlight module and a liquid crystal panel oppositely disposed,
wherein the backlight module provides a display light source for the liquid crystal panel, and
wherein the backlight module comprises:
a light guide plate;
an optical film disposed on a top surface of the light guide plate; and
a light-shielding adhesive, a portion of which adheres to an edge of a top surface of the optical film, and another portion adheres to a side surface of the optical film and a side surface of the light guide plate, and extendedly adheres to an edge of a bottom surface of the light guide plate.

9. The liquid crystal display of claim 8, wherein the light-shielding adhesive takes a shape of U.

10. The liquid crystal display of claim 9, wherein the backlight module does not comprise a glue frame.

11. The liquid crystal display of claim 10, wherein the backlight module does not comprise a glue frame.

12. The liquid crystal display of claim 10, wherein the backlight module further comprises a back frame including a bottom plate and a side plate located at a side end of the bottom plate, the light guide plate is disposed on the bottom plate, and the light-shielding adhesive adhered to the side surface of the optical film and the side surface of the light guide panel adheres to the side plate.

13. The liquid crystal display of claim 11, wherein the backlight module further comprises a back frame including a bottom plate and a side plate located at a side end of the bottom plate, the light guide plate is disposed on the bottom plate, and the light-shielding adhesive adhered to the side surface of the optical film and the side surface of the light guide panel adheres to the side plate.

14. The liquid crystal display of claim 11, wherein the backlight module further comprises a reflector plate disposed between the light-shielding adhesive adhered to the edge of the bottom surface of the light guide plate and the bottom plate.
